(19) United States
(12) Patent Application Publication
(10) Pub. No.: US 2014/0192680 A1
(43) Pub. Date: Jul. 10, 2014

(54) WIRELESS DEVICE AND WIRELESS NETWORK SYSTEM

(71) Applicant: Institute For Information Industry, Taipei (TW)

(72) Inventors: Hsien-Tsung HSU, Taipei City (TW); Kanchei Loa, Taipei City (TW); Chun-Che CHIEN, Taipei City (TW); Yi-Hsueh TSAI, New Taipei City (TW); Tsung-Yu TSAI, Tainan City (TW); Shu-Tsz LIU, Taipei City (TW)

(73) Assignee: Institute For Information Industry, Taipei (TW)

(21) Appl. No.: 14/150,953

(22) Filed: Jan. 9, 2014

Related U.S. Application Data
(60) Provisional application No. 61/750,362, filed on Jan. 9, 2013.
(60) Provisional application No. 61/750,363, filed on Jan. 9, 2013.

(51) Int. Cl. H04W 48/16

(52) U.S. Cl. CPC H04W 48/16
USPC 370/254

(57) ABSTRACT

A wireless device and a wireless network system are provided. The wireless device is configured to discover an under-discovered wireless device, and a first network server serves the under-discovered wireless device. The under-discovered wireless device transmits a terminal signal to the first network server at a specific frequency and in a specific period. The wireless device includes a transceiver and a processor electrically connected to the transceiver. The processor obtains a piece of feature information regarding to the under-discovered wireless device by listening to the terminal signal via the transceiver, and identifies that the under-discovered wireless device is in a discovery coverage of the wireless device based on a determination result that the feature information or a normalized feature information is higher than a predetermined threshold.

### PRIORITY

This application claims the benefit of priorities based on U.S. Provisional Application No. 61/750,362 filed on Jan. 9, 2013 and U.S. Provisional Application No. 61/750,363 filed on Jan. 9, 2013, which are both hereby incorporated by reference in their entirety herein.

### FIELD

The present invention relates to a wireless device for discovering other devices, a wireless network system and discovering methods thereof. More particularly, the wireless device of the present invention uses the feature information of terminal signals of other wireless devices, which are transmitted when the other wireless devices communicate with a network server based on an original system architecture, to identify that the other wireless devices are located within a discovery coverage of the wireless device.

### BACKGROUND

With advancement of the science and technology, ways of utilizing wireless communications have become increasingly diversified. In order to satisfy the users' needs, the device-to-device direct communication has emerged and, correspondingly, the proximity discovery technology has been derived therefrom.

However, the device-to-device proximity discovery is conventionally achieved by using a new communication resource to perform proximity discovery between a wireless device and an under-discovered device. For example, in the Long Term Evolution (LTE) architecture, the wireless network system specially provides the wireless device and the under-discovered wireless device with a new channel for proximity discovery (e.g., discovery based on a sequence signal or discovery based on packet data).

Therefore, the device-to-device proximity discovery technology currently available needs to use new resources. As the devices performing the proximity discovery increases, the system resources consumed and occupied will also increase, which will lead to degradation in the utilization factor of resources of the wireless network system.

Accordingly, an urgent need exists in the art to provide a mechanism capable of improving the utilization factor of the resources of the wireless network system and, meanwhile, achieving the purpose of proximity discovery.

### SUMMARY

An objective of certain embodiments of the present invention is to provide a proximity discovery mechanism that performs proximity discovery by using resources originally used for communication between an under-discovered wireless device and a network server thereof. In this way, the proximity discovery mechanism of the present invention can improve the utilization factor of resources of the wireless network system and, meanwhile, achieve the purpose of proximity discovery.

To achieve the aforesaid objective, certain embodiments of the present invention include a wireless device for discovering an under-discovered wireless device. The under-discovered wireless device is served by a first network server and transmits a terminal signal to the first network server at a specific frequency and in a specific period. The wireless device comprises a transceiver and a processor electrically connected to the transceiver. The processor is configured to obtain a piece of feature information related to the terminal signal by listening to the terminal signal via the transceiver, and identify that the under-discovered wireless device is in a discovery coverage of the wireless device according to a determination result that the feature information is higher than a predetermined threshold.

The present invention in certain embodiments further includes a wireless network system. The wireless network system comprises a first network server, an under-discovered wireless device and a wireless device. The under-discovered wireless device is configured to transmit a terminal signal to the first network server at a specific frequency and in a specific period. The wireless device is configured to discover the under-discovered wireless device, and comprises a transceiver and a processor electrically connected to the transceiver. The processor is configured to obtain a piece of feature information related to the terminal signal by listening to the terminal signal via the transceiver, and identify that the under-discovered wireless device is in a discovery coverage of the wireless device according to a determination result that the feature information is higher than a predetermined threshold.

The present invention in certain embodiments further includes a wireless device for discovering an under-discovered wireless device. The under-discovered wireless device is served by a first network server and transmits a terminal signal to the first network server at a specific frequency and in a specific period. The wireless device comprises a transceiver and a processor electrically connected to the transceiver. The processor is configured to obtain a piece of feature information related to the terminal signal by listening to the terminal signal via the transceiver, and identify that the under-discovered wireless device is in a discovery coverage of the wireless device according to a determination result that the normalized feature information is higher than a predetermined threshold.

The present invention in certain embodiments further includes a wireless network system. The wireless network system comprises a first network server, an under-discovered wireless device and a wireless device. The under-discovered wireless device is configured to transmit a terminal signal to the first network server at a specific frequency and in a specific period. The wireless device is configured to discover the under-discovered wireless device, and comprises a transceiver and a processor electrically connected to the transceiver. The processor is configured to obtain a piece of feature information related to the terminal signal by listening to the terminal signal via the transceiver, and identify that the under-discovered wireless device is in a discovery coverage of the wireless device according to a determination result that the normalized feature information is higher than a predetermined threshold.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a wireless network system according to a first embodiment of the present invention;

FIG. 1B is a block diagram of the wireless network system according to the first embodiment of the present invention;

FIGS. 2A-2C are timing flowchart diagrams of a second embodiment of the present invention;

FIG. 3 is a timing flowchart diagram of a third embodiment of the present invention;

FIG. 4 is a timing flowchart diagram of a fourth embodiment of the present invention;

FIGS. 5A-5C are timing flowchart diagrams of a fifth embodiment of the present invention;

FIG. 6A is a schematic view of a wireless network system according to a sixth embodiment of the present invention;

FIG. 6B is a timing flowchart diagram of a sixth embodiment of the present invention; and

FIG. 7 is a timing flowchart diagram of a seventh embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention, and the scope of this application shall be governed by the claims. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

For convenience of describing the present invention, the proximity discovery mechanism adopted in the wireless network system of the present invention will be described in a context of the Long Term Evolution (LTE) architecture in the following embodiments. However, the present invention is not limited thereto, and the mechanism of the present invention can be adopted in all common wireless network systems to achieve the function of device-to-device proximity discovery.

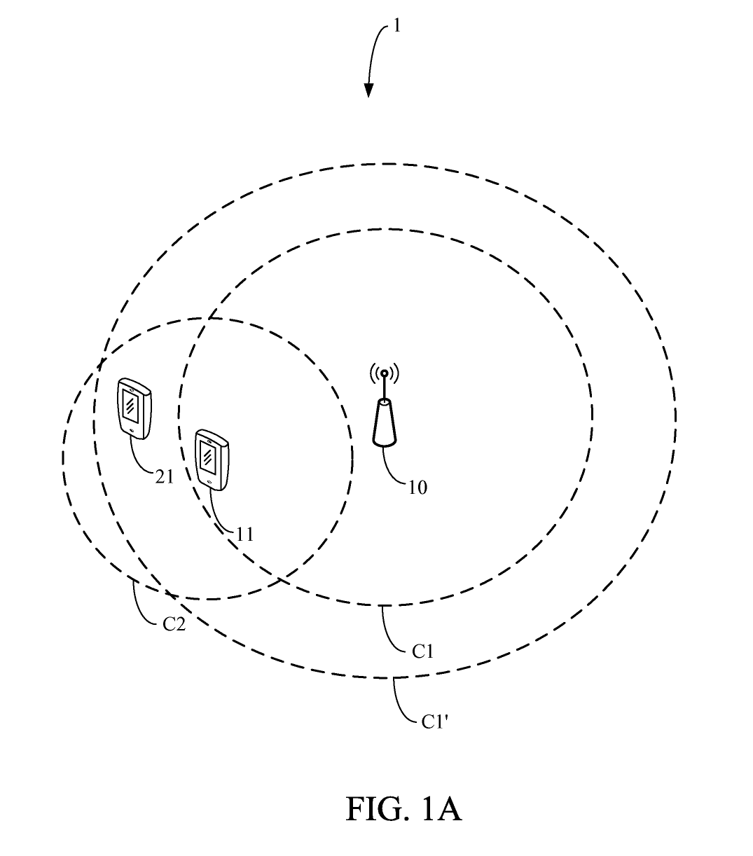

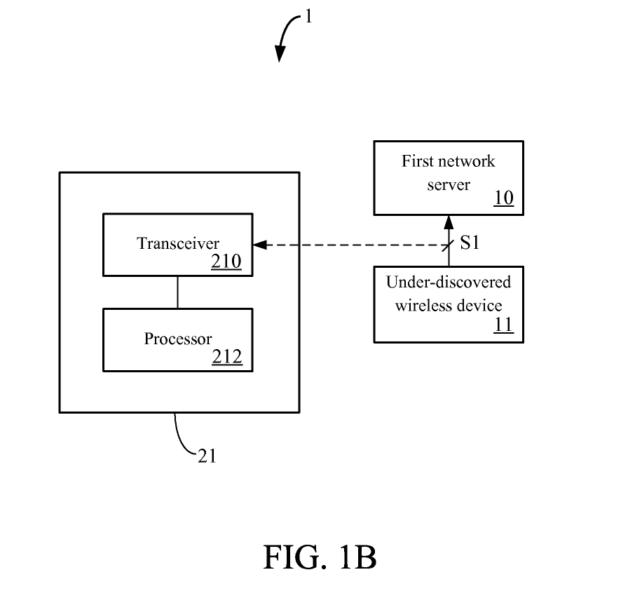

A first embodiment of the present invention is shown in FIG. 1A and FIG. 1B. FIG. 1A is a schematic view of a wireless network system 1, and FIG. 1B is a block diagram of the wireless network system 1. The wireless network system 1 comprises a first network server 10, an under-discovered wireless device 11 and a wireless device 21. The under-discovered wireless device 11 is located within a service coverage C1 or C1′ of the first network server 10, and is served by the first network server 10. The wireless device 21 is configured to discover the under-discovered wireless device 11.

It shall be appreciated that, cases where the wireless device 21 is located within or not located within the service coverage of the first network server 10 will be described hereinbelow. When the service coverage of the first network server 10 is the service coverage C1, the wireless device 21 is not served by the first network server 10; and when the service coverage of the first network server 10 is the service coverage C1′, the wireless device 21 is served by the first network server 10.

It shall be appreciated that, the present invention can be applied to several different types of wireless network systems. For example, if the wireless network system 1 is a wireless local area network (LAN) system, then the first network server 10 is an access point (AP); or the wireless network system 1 may also be a wireless network system based on the LTE architecture, in which case the first network server 10 is an evolved NodeB (eNB). However, the present invention is not limited thereto, and the mechanism of the present invention can be adopted in all common wireless network systems to achieve the function of device-to-device proximity discovery.

In order to plan use of the frequency bands effectively, a specific resource will be used for packet transmission when the under-discovered wireless device 11 communicates with the first network server 10. The specific resource comprises a frequency and a period.

Furthermore, the specific resource is known by both the under-discovered wireless device 11 and the first network server 10. That is, both the under-discovered wireless device 11 and the first network server 10 know that the under-discovered wireless device 11 will transmit a terminal signal S1 to the first network server 10 at a specific frequency and in a specific period.

The wireless device 21 comprises a transceiver 210 and a processor 212 electrically connected to the transceiver 210. Signals transmitted by the under-discovered wireless device 11 can be received by the transceiver 210 when being located within a wireless communication coverage C2 of the under-discovered wireless device 11. Therefore, the terminal signal S1 transmitted by the under-discovered wireless device 11 to the first network server 10 can be received by the transceiver 210. Herein, the behavior of the wireless device 21 monitoring or receiving the signals transmitted by the under-discovered wireless device 11 is called “listening”.

Next, the processor 212 measures the terminal signal S1 via the transceiver 210 and obtains a piece of feature information F1 related to the terminal signal S1 transmitted by the under-discovered wireless device 11, and identifies that the under-discovered wireless device 11 is located within a discovery coverage of the wireless device 21 based on a determination result that the feature information F1 is higher than a predetermined threshold. That is, the under-discovered wireless device 11 is discovered by the wireless device 21 as a result of proximity discovery, thus achieving the purpose of proximity discovery. The predetermined threshold is stored in a storage (not shown) of the wireless device 21.

It shall be particularly appreciated that, the term “identify” used herein does not mean “comparing whether the feature information F1 is higher than the threshold/critical value” or “determining what the under-discovered wireless object is”, but means that the processor 212 “ascertains” existence of an under-discovered wireless device in the discovery coverage of the wireless device 21 after the aforesaid comparison and determination. Which element makes the “determination”, how the “determination” is made and what the determined under-discovered wireless device is will be detailed hereinafter.

Then, the wireless device 21 can create a connection with the under-discovered wireless device 11 according to the proximity discovery result and exchange data with the under-discovered wireless device 11 directly, although this is not required. It shall be appreciated that, the discovery coverage may be an actual wireless communication coverage of the wireless device 21; and if the wireless device 21 performs the proximity discovery for purpose of a specific service, the discovery coverage is a set of one or more wireless devices intended to utilize the specific service and located within the actual communication coverage. How the specific service is utilized will be detailed hereinafter.

Specifically, the feature information F1 is, for example, a receiving power value, which is measured by the wireless device 21, of the terminal signal S1 transmitted by the under-discovered wireless device 11, or is a Signal to Interference plus Noise Ratio (SINR) value calculated according to the receiving power value measured by the wireless device 21. However, the present invention is not limited thereto, and any feature information F1 that can be generated by the wireless device 21 through listening to the terminal signal S1 can be used in the present invention for proximity discovery.

As can be known from the above descriptions, the present invention obtains the feature information (e.g., a power value or other signal measurement and evaluation results) related to the under-discovered wireless device 11 by measuring or analyzing a pre-existing resource (e.g., a channel and/or a signal) between the under-discovered wireless device 11 and the network server thereof. Thereby, a result that the under-discovered wireless device 11 is discovered can be obtained.

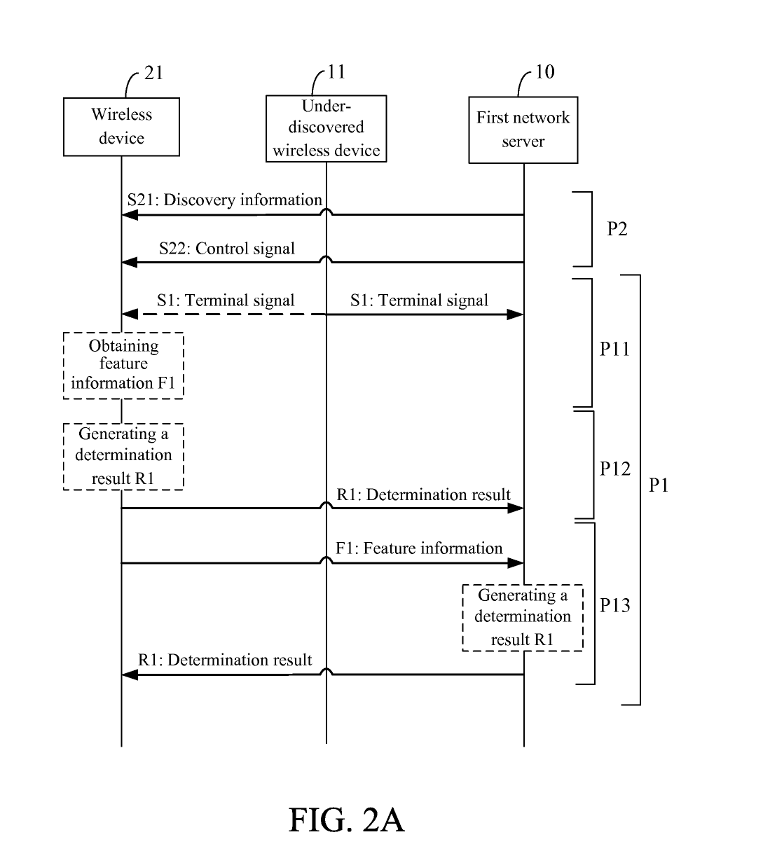

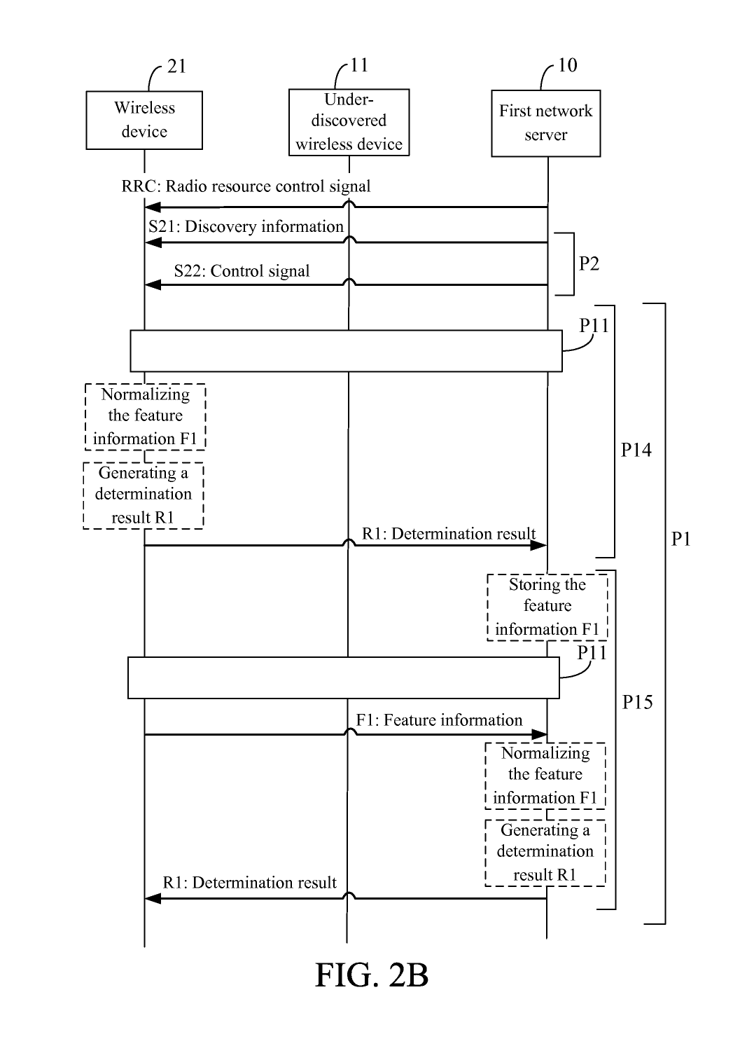

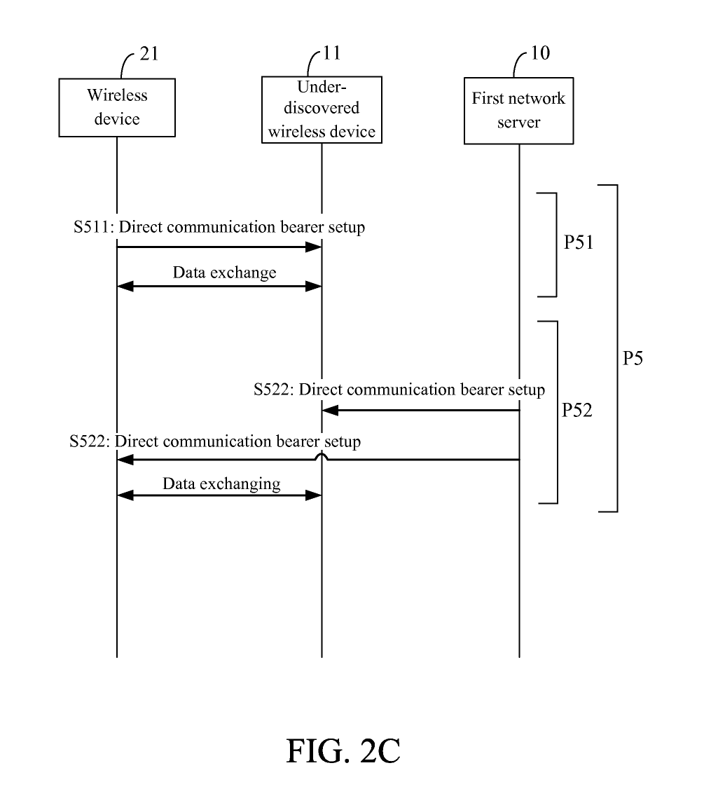

A second embodiment of the present invention is shown in FIGS. 1A-1B and FIGS. 2A-2C. FIGS. 2A-2C depict a timing flowchart diagram of this embodiment respectively. The second embodiment provides a wireless device and a wireless network system for proximity discovery, and the wireless network system, the devices thereof and the signals/information used in this embodiment are just the same as the wireless network system 1, the devices thereof and the signals/information described in the first embodiment.

To clearly describe the timing flow process of the devices of the wireless network system in this embodiment, the process in which the processor 212 obtains the feature information F1 related to the under-discovered wireless device 11 by listening to the terminal signal S1 via the transceiver 210 is integrally defined as a first discovery procedure P11.

The discovery procedure P11 may be implemented in several ways. Hereinbelow, a first discovery procedure P11, a second discovery procedure P12, a third discovery procedure P13, a fourth discovery procedure P14 and a fifth discovery procedure P15 will be described. The first discovery procedure P11 is essential for all implementations. The second discovery procedure P12 and the third discovery procedure P13 are exclusive to the fourth discovery procedure P14 and the fifth discovery procedure P15; that is, if the second discovery procedure P12 or the third discovery procedure P13 is performed, then the fourth discovery procedure P14 or the fifth discovery procedure P15 will not be performed, and vice versa.

The second discovery procedure P12 is also exclusive to the third discovery procedure P13; that is, if the second discovery procedure P12 is performed, then the third discovery procedure P13 will not be performed, and vice versa. The second discovery procedure P12 or the third discovery procedure P13 is performed after the first discovery procedure P11.

The fourth discovery procedure P14 and the fifth discovery procedure P15 include the first discovery procedure P11, and the fourth discovery procedure P14 is exclusive to the fifth discovery procedure P15. That is, if the fourth discovery procedure P14 is performed, then the fifth discovery procedure P15 will not be performed, and vice versa.

Herein, a discovery/scheduled information providing procedure P2 performed prior to the discovery procedure P1 will be firstly described. It shall be appreciated that, because the discovery/scheduled information providing procedure P2 is performed in this embodiment, the wireless device 21 is located in the service coverage C1′ of the first network server 10.

Referring to FIG. 2A, in the discovery/scheduled information providing procedure P2, the first network server 10 transmits a piece of discovery information S21 and a control signal S22 to the wireless device 21. In the LTE architecture, the discovery information S21 may be a broadcast signal, a unicast signal or a multicast signal. The control signal S22 is a control signal pre-existing in the LTE architecture, and is transmitted in the physical downlink control channel (PDCCH).

After the discovery information S21 and the control signal S22 are received by the wireless device 21 via the transceiver 210, the processor 212 can learn from the discovery information S21 a radio network temporary identifier (RNTI) of the under-discovered wireless device 11 and learn from the control signal S22 a piece of resource allocation information of the under-discovered wireless device 11. Thus, the processor 212 learns that the wireless device 11 will transmit the terminal signal S1 at the specific frequency and in the specific period. How to learn that the under-discovered wireless device 11 will transmit the terminal signal S1 at the specific frequency and in the specific period according to the RNTI and the control signal S22 will be readily appreciated by those skilled in the art, so this will not be further described herein.

Alternatively, the first network server 10 may also firstly append the information that the under-discovered wireless device 11 will transmit the terminal signal S1 at the specific frequency and in the specific period into the discovery information S21. Then when the discovery information S21 is received by the wireless device 21, it is unnecessary for the wireless device 21 to learn the information that the wireless device 11 will transmit the terminal signal S1 at the specific frequency and in the specific period according to the control signal S22 or in other ways. Next, the discovery procedure P1 will be performed.

The first discovery procedure P11 of this embodiment may be implemented in four ways, which will be illustrated as follows. In a first implementation, the terminal signal S1 is an arbitrary signal, and the feature information F1 is a power value.

Specifically, the wireless device 21 has learned, through the discovery/scheduled information providing procedure P2, that the under-discovered wireless device 11 will transmit the terminal signal S1 at the specific frequency and in the specific period. Then, the wireless device 21 listens to the terminal signal S1 at the specific frequency and in the specific period, and measure a power at which the terminal signal S1 is transmitted by the under-discovered wireless device 11 to generate a power value. Here, the terminal signal S1 is an arbitrary signal.

In a second implementation, a Signal to Interference plus Noise Ratio (SINR) value is used as the feature information F1 to identify whether the under-discovered wireless device 11 is located within the discovery coverage of the wireless device 21. Here, the terminal signal S1 is an arbitrary signal.

Firstly, the wireless device 21 measures the power value of the terminal signal S1 transmitted by the under-discovered wireless device 11 to the first network server 10. Then, an SINR value is calculated by evaluating the surrounding interfering signals and the background noises. Here, the SINR value is just the feature information F1.

In a third implementation, the terminal signal S1 is a reference signal (RS) or a sounding reference signal (SRS).

Specifically, in the LTE architecture, the reference signal is used for channel estimation to demodulate physical uplink shared channel (PUSCH) data, and the sounding reference signal is used to assist the first network server 10 in evaluating which channels have good conditions so that network resources can be scheduled by the first wireless network server 10 appropriately. When the terminal signal S1 (i.e., the reference signal or the sounding reference signal) is transmitted by the under-discovered wireless device 11 to the first network server 10, the processor 212 listens to the reference signal or the sounding reference signal in the specific channel via the transceiver 210 and measures the reference signal or the sounding reference signal to obtain an unknown sequence.

Next, the processor 212 compares the unknown sequence with a plurality of reference sequences to obtain a plurality of relevance values. Here, the feature information F1 is just the relevance values. The reference sequences are all possible sequences of terminal signals of all devices served by the first network server 10 and are carried in the discovery information S21.

In a fourth implementation, the specific frequency and the specific period correspond to a specific uplink channel (e.g., a physical uplink control channel (PUCCH)). In this case, the terminal signal S1 is a feedback signal (e.g., an ACK/NACK signal) transmitted in the PUCCH. The specific uplink channel may also be a physical random access channel (PRACH), in which case the terminal signal S1 is a preamble transmitted in the PRACH.

Specifically, when the terminal signal S1 is transmitted by the under-discovered wireless device 11 in the specific channel, the processor 212 measures the terminal signal S1 (i.e., the ACK/NACK signal or the preamble) via the transceiver 210 to obtain an unknown sequence.

Similar to the third implementation, then the processor 212 compares the unknown sequence with a plurality of reference sequences to obtain a plurality of relevance values. Here, the feature information F1 is just the relevance values. The reference sequences are all possible sequences of terminal signals of all devices served by the first network server 10 and are carried in the discovery information S21.

It shall be appreciated that, the terminal signals S1 and the feature information F1 of the first to the fourth implementations of the first discovery procedure P11 have been described above, and next the second discovery procedure P12 and the third discovery procedure P13 will be described to illustrate how a determination is made by using the various implementations of the first discovery procedure P11 to generate a determination result R1. It shall be appreciated that, the term “determination” used herein means comparing the feature information with a threshold/critical value, but does not mean “identify”.

Referring next to FIG. 2A, in the second discovery procedure P12, the processor 212 of the wireless device 21 determines that the under-discovered wireless device 11 is located within the discovery coverage of the wireless device 21 and generates a determination result R1 (i.e., that the under-discovered wireless device 11 is located within the discovery coverage of the wireless device 21). Here, the wireless device 21 further comprises a storage (not shown) for storing a predetermined threshold.

In detail, if the feature information F1 is the power value (e.g., the power value described in the first implementation of the first discovery procedure P11), the predetermined threshold is a predetermined power threshold, and the processor 212 determines that the power value is higher than the predetermined power threshold to generate a determination result R1. If the feature information F1 is the SINR value (e.g., the SINR value described in the second implementation of the first discovery procedure P11), the predetermined threshold is a predetermined SINR threshold, and the processor 212 determines that the SINR value is higher than the predetermined SINR threshold to generate a determination result R1.

If the feature information F1 is the relevance values (e.g., the relevance values described in the third implementation or the fourth implementation of the first discovery procedure P11), the predetermined threshold is a predetermined relevance value, and the processor 212 makes a determination according to the relevance values to generate a determination result R1.

Further speaking, the processor 212 determines that a specific relevance value between the unknown sequence and a specific sequence of the plurality of reference sequences is higher than the predetermined relevance value, and it can be known from a sequence-RNTI mapping table that the specific sequence corresponds to the RNTI of the under-discovered wireless device 11. This means that the under-discovered wireless device 11 is discovered by the wireless device 21. The processor 212 determines that the wireless device 11 is located within the discovery coverage of the wireless device 21 to generate a determination result R1. The sequence-RNTI mapping table is appended in the discovery information S21 transmitted to the wireless device 21.

It shall be appreciated that, if the wireless device 21 has already had the sequence-RNTI mapping table which comprises related information of the reference sequences, then it will be unnecessary for the first network server 10 to repeatedly transmit the reference sequences in the third implementation and the fourth implementation of the first discovery procedure P11; and instead, the relevance values can be calculated according to the sequence-RNTI mapping table directly.

Once the determination result R1 is generated, the wireless device 21 identifies that the under-discovered wireless device 11 is located within the discovery coverage of the wireless device 21 according to the determination result R1, and can transmit the determination result R1 to the first network server 10 via the transceiver 210 so that the determination result R1 is recorded by the first network server 10. Content of the determination result R1 may further comprise an identification (ID) code of the under-discovered wireless device 11, which may be the aforesaid RNTI or a global identification code. However, transmitting the determination result R to the first network server is not required.

Next, the third discovery procedure P13 will be described. In this procedure, the first network server 10 determines that the under-discovered wireless device 11 is located within the discovery coverage of the wireless device 21 and generates a determination result R1. Firstly, the transceiver 210 transmits the feature information to the first network server 10. Then, the first network server 10 determines that the feature information F1 is higher than a predetermined threshold to generate a determination result R1. Of course, the predetermined threshold is stored in the first network server 10 in advance.

If the feature information F1 is the power value (e.g., as described in the first implementation of the first discovery procedure P11), the predetermined threshold is a predetermined power threshold, and the first network server 10 determines that the power value is higher than the predetermined power threshold to generate a determination result R1. If the feature information F1 is the SINR value (e.g., as described in the second implementation of the first discovery procedure P11), the predetermined threshold is a predetermined SINR threshold, and the first network server 10 determines that the SINR value is higher than the predetermined SINR threshold to generate a determination result R1.

If the feature information F1 is the relevance values (e.g., the relevance values described in the third implementation or the fourth implementation of the first discovery procedure P11), the predetermined threshold is a predetermined relevance threshold, and the first network server 10 makes a determination according to the relevance values and a sequence-RNTI mapping table stored therein to generate a determination result R1.

Further speaking, the first network server 10 determines that a specific relevance value between the unknown sequence and a specific sequence of the plurality of reference sequences is higher than the predetermined relevance value, and it can be known from a sequence-RNTI mapping table stored in the first network server 10 that the specific sequence corresponds to the RNTI of the under-discovered wireless device 11. This means that the device discovered by the wireless device 21 is the under-discovered wireless device 11. The first network server 10 determines that the wireless device 11 is located within the discovery coverage of the wireless device 21 to generate a determination result R1.

It shall be appreciated that, once the determination result R1 is generated, the determination result R1 is transmitted by the first network server 10 to the transceiver 210 so that the processor 212 identifies that the under-discovered wireless device 11 is located within the discovery coverage of the wireless device 21 according to the determination result R1. Content of the determination result R1 may further comprise an identification (ID) code of the under-discovered wireless device 11, which may be the aforesaid RNTI or a global identification code.

Different from the first to the third discovery procedures P11-P13 described above, a fourth discovery procedure P14 and a fifth discovery procedure P15 are provided in another implementation of this embodiment. It is emphasized again that, the fourth discovery procedure P14 is exclusive to the fifth discovery procedure P15; that is, if the fourth discovery procedure P14 is performed, then the fifth discovery procedure P15 will not be performed, and vice versa.

Referring to FIG. 2B, the fourth discovery procedure P14 and the fifth discovery procedure P15 differ from the first to the third discovery procedures P11-13 in that, the processor 212 or the first network server 10 may also normalize the power value of the terminal signal S1 received by the transceiver 210, and then determine whether the normalized power value is higher than the predetermined power threshold or whether the SINR value calculated according to the normalized power value is higher than the predetermined SINR threshold to generate a determination result R1. Because this embodiment mainly focuses on normalization of the power value, the feature information F1 set forth in this embodiment is the power value or the SINR value (which applies only to the first or the second implementations of the first discovery procedure P11).

Firstly, the fourth discovery procedure P14 will be described. The normalization information used herein is appended by the first network server 10 into the discovery information S21 or a Radio Resource Control (RRC) signal RRC and transmitted to the wireless device 21. The normalization information comprises a transmitting power value that the first network server 10 requests the under-discovered wireless device 11 to use when transmitting a signal.

After the first implementation of the first discovery procedure P11 is performed, firstly the power value is obtained by the wireless device 21. Then, the determination result R1 can be generated directly by the processor 212 through determining that the normalized power value is higher than the predetermined power threshold or determining that the SINR value calculated according to the normalized power value is higher than the predetermined SINR threshold. Then, the processor 212 identifies that the under-discovered wireless device 11 is located within the discovery coverage of the wireless device 21. Thereafter, the determination result R1 is transmitted to the first network server 10 for recording, although this is not required.

However, the present invention is not limited thereto. In another implementation (not shown), the normalized power value or the SINR value calculated according to the normalized power value is transmitted as the feature information F1 to the first network server 10 so that a determination result R1 is generated by the first network server 10 by determining that the normalized power value is higher than the predetermined power threshold or determining that the SINR value calculated according to the normalized power value is higher than the predetermined SINR threshold. Then, the determination result R1 is transmitted back to the wireless device 21 so that the processor 212 identifies that the under-discovered wireless device 11 is located within the discovery coverage of the wireless device 21 according to the determination result R1.

Next, the fifth discovery procedure P15 will be described. The fifth discovery procedure P15 differs from the fourth discovery procedure P14 in that, it is the first network server 10 that normalizes the feature information F1 (here, this is only limited to the power value described in the first implementation of the first discovery procedure P11). Firstly, the first network server 10 stores the normalization information into a storage of its own (without the need to transmit the normalization information to the wireless device 21), and the feature information F1 is transmitted by the transceiver 210 to the first network server 10. Then, the feature information F1 (i.e., the power value) is normalized by the first network server 10, and the determination result R1 by determining that the normalized feature information F1 (the normalized power value) is higher than the predetermined power threshold is generated by the first network server 10 directly.

Afterwards, the determination result R1 is transmitted by the first network server 10 to the transceiver 210 of the wireless device 21 so that the processor 212 identifies that the under-discovered wireless device 11 is located within the discovery coverage of the wireless device 21 according to the determination result R1.

Please refer next to FIG. 2C. In other implementations, the present invention may also perform an allocation procedure P5 for allocating a resource to the wireless device 21 and the under-discovered wireless device 11. In the LTE architecture, the resource refers to a channel used for direct communication between the wireless device 21 and the under-discovered wireless device 11. The allocation procedure P5 may be implemented in two ways, namely, a first allocation procedure P51 and a second allocation procedure P52.

The first allocation procedure P51 and the second allocation procedure P52 are exclusive to each other and cannot be performed simultaneously. The first allocation procedure P51 and the second allocation procedure P52 are both depicted in FIG. 2C just for purpose of comparison but not for limitation. Furthermore, the allocation procedure P5 is not required in the present invention.

In the first allocation procedure P51, the wireless device 21 generates a direct communication bearer setup S511 according to the communication needs between the wireless device 21 and the under-discovered wireless device 11, and transmits the direct communication bearer setup S511 to the under-discovered wireless device 11 to inform that the resource has been provided to the wireless device 21 and the under-discovered wireless device 11. Thereafter, data can be exchanged between the wireless device 21 and the under-discovered wireless device 11 directly according to the resource without the need of any network server.

In the second allocation procedure P52, it is the first network server 10 that allocates the resource to the wireless device 21 and the under-discovered device 11. In detail, the first network server 10 transmits a direct communication bearer setup 5522 to the wireless device 21 and the under-discovered wireless device 11 to inform that the resource has been allocated to the wireless device 21 and the under-discovered wireless device 11.

Thereafter, data can be exchanged between the wireless device 21 and the under-discovered wireless device 11 directly according to the resource without the need of any network server. Of course, the premise of using this procedure is that the wireless device 21 must be located within the service coverage C1′ of the first network server 10.

Of course, the wireless device 21 may also exchange data with the under-discovered wireless device 11 according to other communication standards (e.g., Wireless Fidelity (WiFi)) after the under-discovered wireless device 11 has been discovered. This can be appreciated by those skilled in the art and, thus, will not be further described herein.

Here, exemplary examples of using the various implementations of the discovery procedure P1, the discovery/scheduled information providing procedure P2 and the allocation procedure P5 in combination will be illustrated. Example 1: performing the discovery/scheduled information providing procedure P2, the first implementation of the first discovery procedure P11 and the second discovery procedure P12; example 2: performing the discovery/scheduled information providing procedure P2 and the fifth discovery procedure P15; example 3: performing the discovery/scheduled information providing procedure P2 and the third implementation of the first discovery procedure P11; and example 4: performing the discovery/scheduled information providing procedure P2 and the fourth implementation of the first discovery procedure P11.

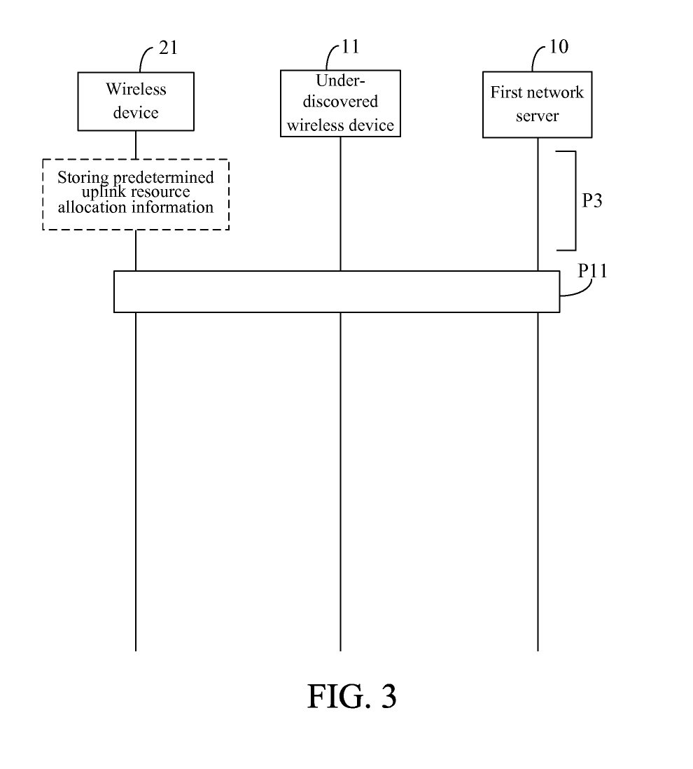

A third embodiment of the present invention is shown in FIG. 1A, FIG. 1B and FIG. 3. FIG. 3 is a timing flowchart diagram of the third embodiment. This embodiment provides another implementation different from the discovery/scheduled information providing procedure P2: the information that the under-discovered wireless device 11 will transmit the terminal signal S1 at the specific frequency and in the specific time can also be obtained through a resource pre-allocation procedure P3 instead of the discovery/scheduled information providing procedure P2.

It shall be particularly appreciated that, the implementation in which the resource pre-allocation procedure P3 is used takes the service coverage of the first network server 10 as the service coverage C1. Because the first network server 10 does not serve the wireless device 21, the wireless device 21 is unable to obtain, via the first network server 10, the information that the terminal signal 51 is transmitted at the specific frequency and in the specific period.

In this embodiment, the wireless device 21 further comprises a storage (not shown), which is configured to store a piece of predetermined uplink resource allocation information of the under-discovered wireless device 11 that is allocated in advance. The wireless device 21 can learn from the predetermined uplink resource allocation information that the under-discovered wireless device 11 will transmit the terminal signal 51 at the specific frequency and in the specific frequency. For example, the predetermined uplink resource allocation information may be preset by the system or be transmitted from an Evolved Packet Core (EPC) of the wireless device 21 via the server or from the first wireless network server 10. The storage of the wireless device 21 has the predetermined uplink resource allocation information stored therein, and the wireless device 21 listens to the terminal signal S1 of the under-discovered wireless device 11 according to the predetermined uplink resource allocation information.

Then, the processor 212 obtains the feature information F1 through the first, the second, the third or the fourth implementation of the first discovery procedure P11. Thereafter, the processor 212 generates a determination result R1 in the way described in the second discovery procedure P12 and, accordingly, identifies that the under-discovered wireless device 11 is located within the discovery coverage of the wireless device 11. However, because the wireless device 21 is not located within the service coverage of the first network server 10, the procedure of transmitting the determination result R1 to the first network server 10 in the second discovery procedure P12 will not be performed.

It shall be appreciated that, if the third or the fourth implementation of the first discovery procedure P11 is performed in this embodiment, the predetermined uplink resource allocation information further comprises the sequence-RNTI mapping table.

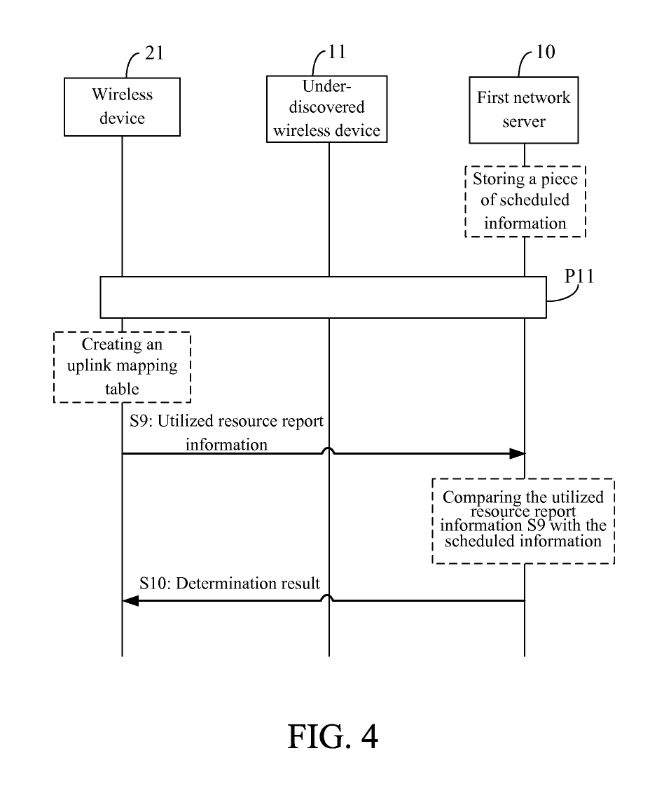

A fourth embodiment of the present invention is shown in FIG. 1A, FIG. 1B and FIG. 4. FIG. 4 is a timing flowchart diagram of the fourth embodiment. A wireless network system and components thereof in this embodiment are the same as those of the second embodiment, and all the procedures in the second embodiment will also be used herein. In this embodiment, the wireless device 21 is located within the service coverage C1′ of the first network server 10. Because the first network server 10 does not transmit the discovery information S21 to the wireless device 21, the wireless device 21 is unable to know the RNTI of the under-discovered wireless device 11 and is unable to know at which frequency and in which period the terminal signal S1 will be transmitted. Therefore, the wireless device 21 must make an overall search at all frequencies and in all periods.

Firstly, the first network server 10 has a piece of scheduled information stored in the storage thereof. The scheduled information comprises related information of all devices served by the first network server 10, and the related information is, for example, an uplink resource or a sequence-RNTI mapping table used by the devices. However, because the wireless device 21 does not know information related to the under-discovered wireless device 11, the first discovery procedure P11 must be performed on each frequency and each period.

After the first discovery procedure P11 has been performed on each frequency and each period, the processor 212 creates an uplink mapping table to record feature information of each device discovered at each possible frequency and in each possible period (of course, the feature information F1 corresponding to the terminal signal 51 of the under-discovered wireless device 11 is also included therein). Then, the processor 212 retrieves one of the pieces of utilized resource report information S9 and transmits it to the first network server 10. The utilized resource report information S9 comprises the feature information F1.

If the feature information is a power value, then the uplink transmission mapping table is, for example, as shown in the following table:

| | | |
|---|---|---|
| Second feature | Third feature | Third feature |
| information | information | information |
| Fourth feature | Feature informa- | Fifth feature |
| information | tion F1 | information |
| Sixth feature | Seventh feature | Eighth feature |
| information | information | information |

In this table, the longitudinal axis and the horizontal axis represent the frequency and the time respectively. The content of each cell represents the feature information which, for example, comprises the feature information F1, a piece of second feature information, a piece of third feature information, a piece of fourth feature information, a piece of fifth feature information, a piece of sixth feature information, a piece of seventh feature information and a piece of eighth feature information.

The first network server 10 determines that the under-discovered wireless device 11 is located within the discovery coverage of the wireless device 21 based on a determination that the feature information F1 in the utilized resource report information is higher than a predetermined threshold stored in the first network server 10 and according to the scheduled information. Thus, a determination result R10 is generated and transmitted by the first network server 10 to the wireless device 21 so that the wireless device 21 identifies that the under-discovered wireless device 11 is located within the discovery coverage of the wireless device 21.

Of course, the first network server 10 may also not transmit the determination result R10 to the wireless device 21, but transmit a direct communication bearer setup (not shown) to the wireless device 21 and the under-discovered wireless device 11 directly. Then, data can be exchanged between the wireless device 21 and the under-discovered wireless device 11 according to the resource allocated to the wireless device 21 and the under-discovered wireless device 11 that is carried in the direct communication bearer setup without the need of any network server.

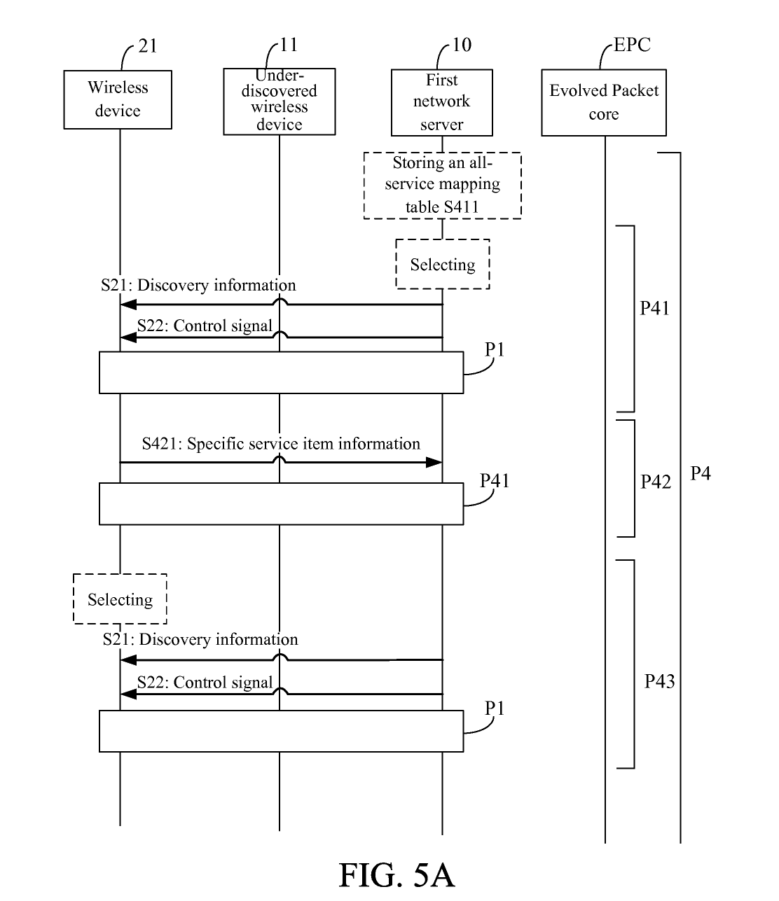

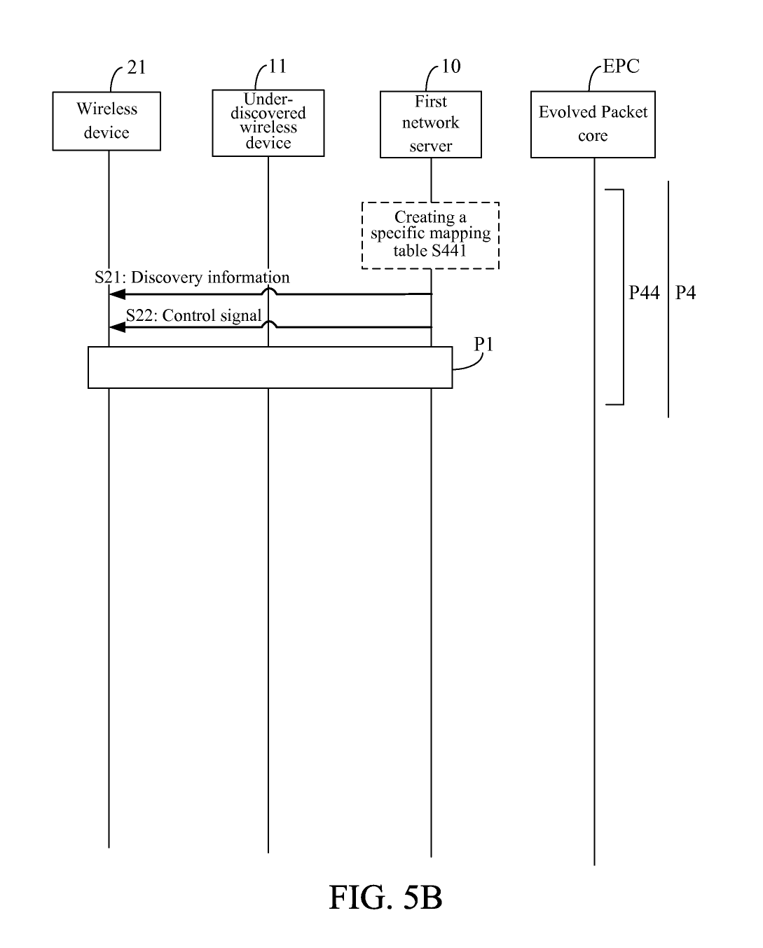

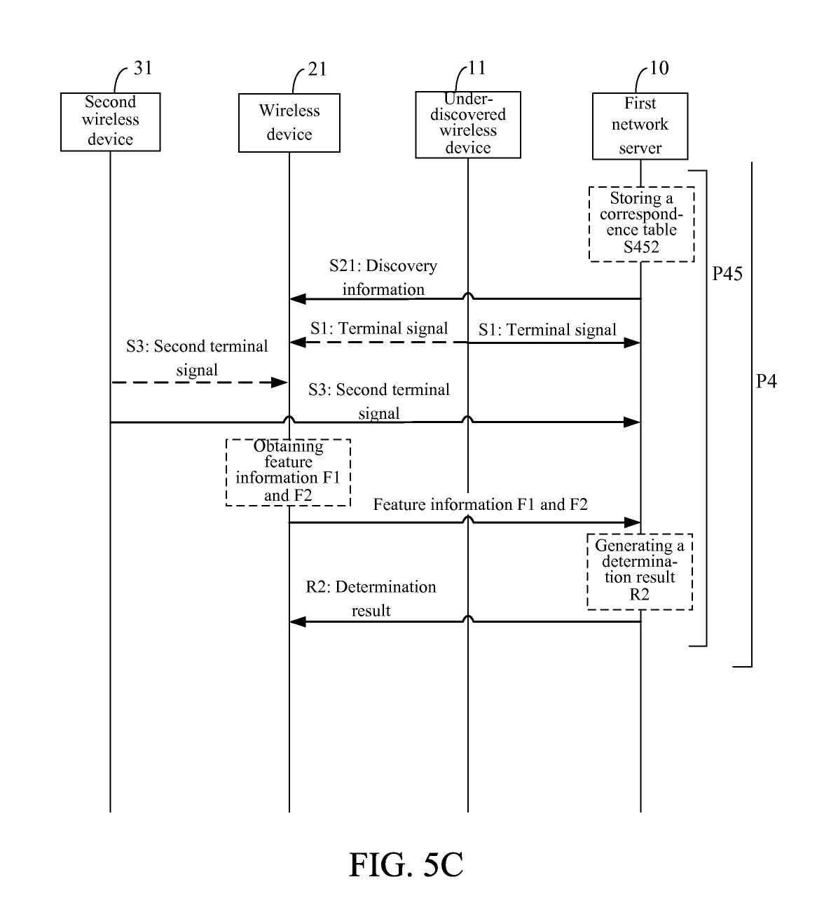

A fifth embodiment of the present invention is shown in FIG. 1A, FIG. 1B, and FIGS. 5A-5C. FIGS. 5A-5C show a timing flowchart diagrams of the present invention. In this embodiment, a service item reserving procedure P4 may be performed prior to the discovery procedure P1 to avoid unnecessary device discovery and to achieve the purpose of specific service discovery. In this embodiment, a wireless network system and components thereof are the same as those of the second embodiment, and all the procedures in the second embodiment will also be used.

The service item reserving procedure P4 may be implemented in several ways. Hereinbelow, a first service item reserving procedure P41, a second service item reserving procedure P42, a third service item reserving procedure P43, a fourth service item reserving procedure P44 and a fifth service item reserving procedure P45 will be described. The first to the fifth service item reserving procedures are exclusive to each other and are depicted in the same drawing just for purpose of convenience but not to mean that they can be performed simultaneously.

It shall be particularly appreciated that, if a service item is to be reserved by using the service item reserving procedure P4, the wireless device 21 must be located within the service coverage C1′ of the first network server 10 and the first to the fourth service item reserving procedures P41-P44 must have the discovery/scheduled information providing procedure P2, but the fifth service item reserving procedure P45 does not need the discovery/scheduled information providing procedure P2. No matter which one of the service item reserving procedures is used, the first network server 10 has an all-service mapping table S411 stored therein. The all-service mapping table S411 in principle records related information of all devices served by the first network server 10 (including the service codes used by the devices), as shown by the following Table 1:

TABLE 1

| | Device |
|---|---|
| First service code | Wireless device, third wireless device |
| Second service code | Wireless device, under-discovered wireless |
| | device, second wireless device |
| Third service code | Second wireless device, third wireless device |

Services corresponding to these service codes are, for example, services of a messaging system, services of a network telephone system and so on. The all-service mapping table S411 is, for example, transmitted by the EPC to the first network server, although it is not limited thereto.

The first to the third service item reserving procedure P41-P43 are shown in FIG. 5A.

In the first service item reserving procedure P41, the first network server 10 selects wireless devices, which use the specific service code, in the all-service mapping table S411. For example, only the second service code in Table 1 is selected. Correspondingly, the first network server 10 selects the wireless device 21, the under-discovered wireless device 11 and a second wireless device that correspond to the second service code from the all-service mapping table S411.

Then, the RNTIs of only the wireless device 21, the under-discovered wireless device 11 and the second wireless device are appended into the discovery information 21, and the first network server 10 also only needs to transmit the discovery information S21 to the wireless device 21, the under-discovered wireless device 11 and a second wireless device that correspond to the second service code, but not to all wireless devices served by the first network server 10.

Next, the first network server 10 transmits the discovery information S21 and the control signal S22 to the wireless device 21 through the discovery/scheduled information providing procedure P2 as described in the second embodiment. Upon receiving the discovery information S21 and the control signal S22, the wireless device 21 will know the frequency and the period used by the under-discovered wireless device 11 to transmit the terminal signal S1 thereof as well as the frequency and the period used by the second wireless device to transmit the terminal signal thereof. Then according to such information, the wireless device 21 performs the discovery procedure P1 as described in the second embodiment at the frequency and in the period used by the under-discovered wireless device 11 to transmit the terminal signal S1 and at the frequency and in the period used by the second wireless device to transmit the terminal signal thereof, thus obtaining a determination result R1. Accordingly, the wireless device 21 identifies that the under-discovered wireless device 11 is located within the discovery coverage of the wireless device 21.

The second service item reserving procedure P42 differs from the first service item reserving procedure P41 in that, firstly one or more service items are provided by the wireless device 21 to generate a piece of specific service item information S421. The specific service item information S421 is transmitted by the wireless device 21 to the first network server 10 via the transceiver 210 and then, from the specific service item information S421 and the all-service mapping table S411, the first network server 10 can know wireless devices corresponding to the specific service item information S421 and served by itself.

Afterwards, the first network server 10 appends the RNTIs of the wireless devices corresponding to the specific service item information S421 into the discovery information S21 as described in the first service item reserving procedure P41, and other processes are as described in the first service item reserving procedure P41 and, thus, will not be further described.

In the third service item reserving procedure P43, the all-service mapping table S411 is appended into the discovery information S21 directly and transmitted to the wireless device 21 by the first network server 10 without any selection. In this case, the discovery information S21 is broadcasted by the first network server 10 to all wireless devices served by the first network server 10.

The wireless device 21 receiving the discovery information S21 selects, according to a service code it needs, the wireless devices corresponding to the desired service code from the all-service mapping table S411 so as to reduce the discovery range, and learns from the discovery information S21 and the control signal S22 transmitted by the first network server 10 the RNTIs of these wireless devices or the frequencies and periods used by the respective wireless devices to transmit their terminal signals.

Then, the discovery procedure P1 as described in the second embodiment is performed to obtain a determination result R1, which will not be further detailed herein. Furthermore, the wireless device 21 identifies that the under-discovered wireless device is located within the discovery coverage of the wireless device 21 according to the determination result R1.

In other implementations, the wireless device 21 and the under-discovered wireless device 11 may also discover each other. For example, if the purpose of the discovery to be performed by the wireless device 21 and the under-discovered wireless device 11 is related to the second service code in Table 1, the discovery information S21 and the control signal S22 broadcasted by the first network server 10 are received by the wireless device 21 and the under-discovered wireless device 11. If the searching role is played by the wireless device 21, then the RNTIs and the resources which the terminal signals used of the under-discovered wireless device 11 and the second wireless device corresponding to the second service code will be obtained through selection according to the all-service mapping table S411 appended in the discovery information S21, the discovery information S21 and the control signal S22.

Similarly, if the searching role is played by the under-discovered wireless device 11, then the RNTIs and the resources which the terminal signals used of the wireless device 21 and the second wireless device corresponding to the second service code will be obtained through selection according to the all-service mapping table S411 appended in the discovery information S21, the discovery information S21 and the control signal S22.

Next, the wireless device 21 and the under-discovered wireless device 11 identify that they are located within each other's discovery coverage in the same way as how the wireless device 21 identifies the under-discovered wireless device 11 in the third service item reserving procedure P43. The mutual discovery is mainly based on the property and demands of the service used by the wireless device 21 and the under-discovered wireless device 11. For example, the service corresponding to the second service code is a service that requires mutual discovery.

The fourth service item reserving procedure P44 is shown in FIG. 5B. In the fourth service item reserving procedure P44, the first network server 10 also has the all-service mapping table S411 stored therein in advance. Then, the first network server 10 creates a specific service mapping table for each of the wireless devices it serves according to the service used by the wireless device respectively.

As an example, the first network server 10 creates a specific mapping table S441 for the wireless device 21 according to information in the all-service mapping table S411 as follows:

TABLE 2

| | | Device |
|---|---|---|
| Wireless | First service code | Third wireless device |
| device 21 | Second service | Under-discovered wireless device 11, the |
| | code | second wireless device |

Because only services corresponding to the first service code and the second service code are used by the wireless device 21 in the all-service mapping table S411, the specific mapping table S441 of the wireless device 21 only comprises wireless devices corresponding to the first service code and the second service code.

Then, the specific mapping table S441 is appended into the discovery information S21 by the first network server 10. Here, the discovery information S21 is a unicast signal because the specific mapping table of each wireless device served by the first network server 10 is different from those of other wireless devices.

Based on concepts similar to those of other service item reserving procedures, the wireless device 21 receiving the discovery information S21 and the control signal S22 from the first network server 10 will perform the discovery procedure P1 to identify that the under-discovered wireless device 11 is located within the service coverage.

It shall be appreciated that, the wireless device 21 only needs to discover devices corresponding to the second service code of the specific mapping table S441 in this procedure. Therefore, even if terminal signals from the under-discovered wireless device 11, the second wireless device and the third wireless device are received by the wireless device 21, the third wireless device is not located within the discovery coverage of the wireless device 21 because the service corresponding to the second service code is not used by the third wireless device.

For the discovery/scheduled information providing procedure P2 in the first to the fourth service item reserving procedures P41 to P44, the content of the discovery information S21 varies with the different service item reserving procedures P4. In the discovery procedure P1, the wireless device 21 obtains the feature information F1 of the under-discovered wireless device 11 by using the terminal signal S1 and the information (an RNTI of a specific service code or a specific mapping table, and etc.) appended in the discovery information S21 of the discovery information S21.

Next, the fifth service item reserving procedure P45 is shown in FIG. 5C. In the fifth service item reserving procedure P45, the first network server 10 also has the all-service mapping table S411 and a correspondence table S452 stored therein in advance. The correspondence table S441 records correspondence relationships between individual devices and resources used by the individual devices. The fifth service item reserving procedure P45 is substantially the same as the fourth service item reserving procedure P44 except that: a specific mapping table S451 in this procedure further provides resource blocks used by the wireless devices in the specific mapping table S441 besides the information of the specific mapping table S441 of the fourth service item reserving procedure P44. The specific mapping table S451 is illustrated in the following Table 3:

TABLE 3

| | | Device | |
|---|---|---|---|
| Wireless | First service code | Third wireless device | First resource |
| device 21 | | | block |
| | Second service | Under-discovered | Second resource |
| | code | wireless device 11 | block |
| | | Second wireless | |
| | | device 31 | |

Please refer to Table 3 for description. If what to be discovered by the wireless device 21 is the under-discovered wireless device 11 corresponding to the second service code, the wireless device 21 will only know that devices corresponding to the second service code are the under-discovered wireless device 11 and the second wireless device 31 and that the resource used by the under-discovered wireless device 11 and the second wireless device 31 is a second resource block, but will not know resource blocks used by the under-discovered wireless device 11 and the second wireless device 31 respectively. Alternatively, the field “device” may even be absent from Table 3, in which case the wireless device 21 listens in the whole second resource block.

Therefore, the wireless device 21 performs a first discovery procedure P11 in the second resource block, that is, listens to the terminal signal S1 and a second terminal signal S3 transmitted by the under-discovered wireless device 11 and the second wireless device 31 respectively and generates the feature information F1 and a piece of second feature information F2 respectively in the way as described in the first to the fifth implementations of the first discovery procedure P11. Then, the feature information F1 and the second feature information F2 are transmitted to the first network server 10.

Next, the first network server 10 generates a determination result R2 by performing the process of obtaining a determination result in the third discovery procedure P13 or the fifth discovery procedure P5, and compares the determination result R2 with the correspondence table S452 stored therein previously to determine that the under-discovered wireless device 11 is located within the discovery coverage of the wireless device 21 (i.e., the under-discovered wireless device 11 is discovered by the wireless device 21). Finally, the determination result R2 is transmitted to the wireless device 21 so that the wireless device 21 defines that the under-discovered wireless device 11 is located within the discovery coverage of the wireless device 21.

In this embodiment, the first allocation procedure P51 described in the second embodiment is performed after the determination result R2 is transmitted from the first network server 10 to the wireless device 21. However, the first allocation procedure P51 is not required, and may not be performed either. Alternatively, the second allocation procedure P52 is performed directly by the first network server 10 without transmitting the determination result R2 to the wireless device 21.

In other implementations, the specific mapping table 5451 records the resource blocks in such a way that resource blocks of individual wireless devices are indicated accurately in the specific mapping table 5451. In case of such an implementation, the processor 212 can determine by itself that the under-discovered wireless device 11 is located within the discovery coverage of the wireless device 21 directly according to the feature information F1. This determination may be made in the way described in the second discovery procedure P12 or the fourth discovery procedure P14 of the second embodiment. Of course, the allocation procedure P5 may be performed finally, although this is not required.

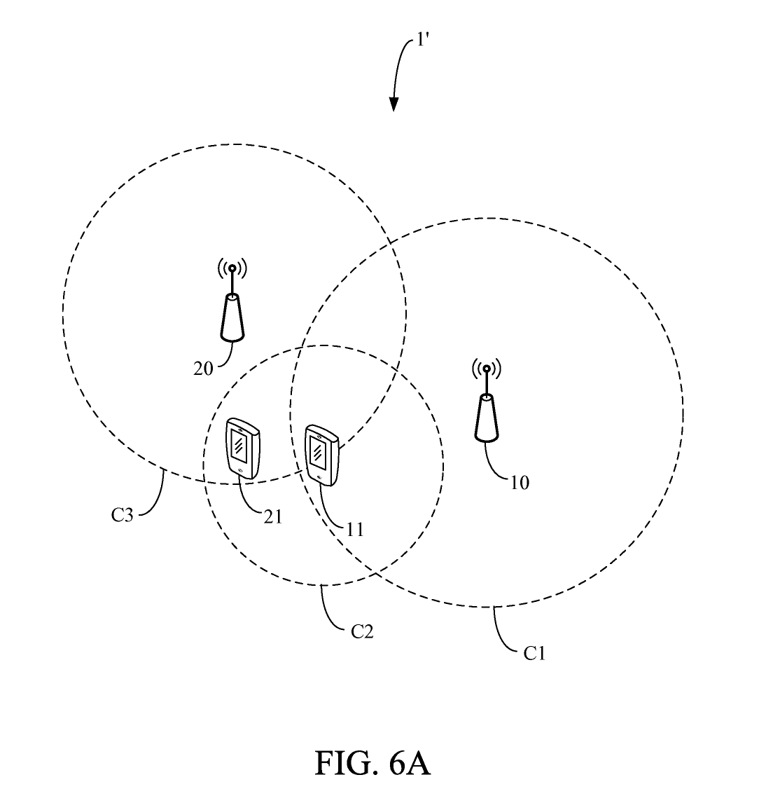

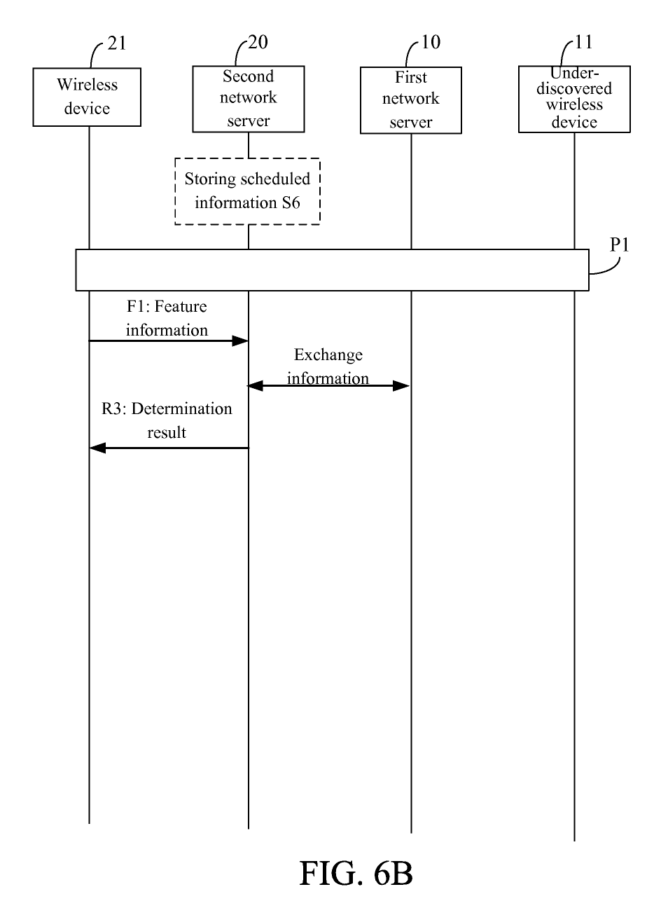

A sixth embodiment of the present invention is shown in FIG. 6A and FIG. 6B. FIG. 6A is a schematic view of a wireless network system 1′ according to this embodiment, and FIG. 6B is a timing flowchart diagram of this embodiment. It shall be appreciated that, devices in the wireless network system 1′ of this embodiment are substantially the same as those of the second embodiment except that: the wireless network system 1′ further comprises a second network server 20, the wireless device 21 is located within a service coverage C3 of the second network server 30 and, thus, is served by the second network server 20, and the under-discovered wireless device 11 is served by the first network server 10. Therefore, in this embodiment, the wireless device 21 is not also served by the first network server 10 as in the second embodiment. Here, the procedures of the second embodiment will also be used in this embodiment.

In this embodiment, the second network server 20 stores a piece of scheduled information S6 related to resources that it schedules; and the wireless device 21 performs the first discovery procedure P11 to obtain the feature information F1 by measuring the terminal signal S1 of the under-discovered wireless device 11.

It shall be particularly appreciated that, because the wireless device 21 is not informed of the related information of the under-discovered wireless device 11 before the discovery procedure P11 is performed, the wireless device 21 does not know when and at which frequency the under-discovered wireless device 11 will transmit the terminal signal S1. Therefore, the wireless device 21 obtains the feature information F1 by listening in all periods and at all frequencies.

Upon obtaining the feature information F1, the wireless device 21 transmits the feature information F1 to the second network server 20. By comparing the feature information F1 with the content of the scheduled information S6, the second network server 20 finds that no data conforming to the feature information F1 is found in the scheduled information S6. Therefore, the second network server 20 request a piece of scheduled information from the adjacent first network server 10 (information exchange) to ascertain that the under-discovered wireless device 11 is served by the first network server 10. Then, it is determined that the under-discovered wireless device 11 is located within the discovery coverage of the wireless device 21 to generate a determination result R3. This determination may be made in the way described in the second discovery procedure P12, so it will not be further described herein.

Then, the first network server 10 transmits the determination result R3 to the wireless device 21 so that the wireless device 21 identifies that the under-discovered wireless device 11 is located within the discovery coverage of the wireless device 21.

It shall be appreciated that, in the LTE architecture, the resource is a channel and the second network server 20 and the first network server 10 exchange information therebetween via an X2 interface.

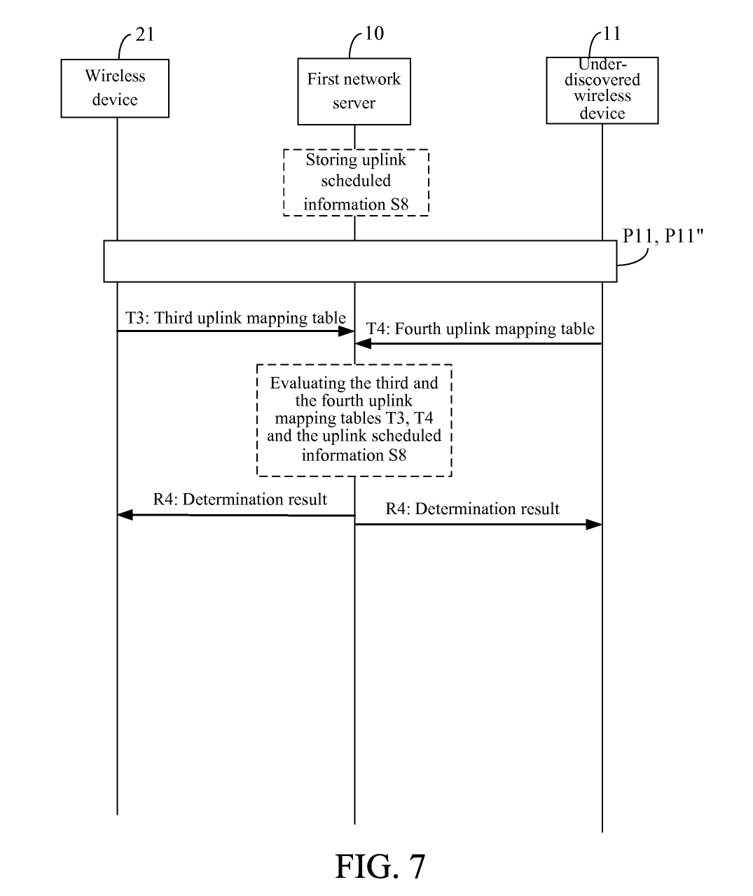

A seventh embodiment of the present invention is shown in FIG. 7, which depicts a timing flowchart diagram of the seventh embodiment. It shall be appreciated that, the wireless network system of this embodiment is substantially the same as the wireless network system 1 of the second embodiment, and the wireless device 21 is located within the service coverage C1′ of the first network server 10. In this embodiment, the wireless device 21 and the under-discovered wireless device 11 act both as discovering devices and discovered devices, and a two-way discovery is performed therebetween. The procedures described in the second embodiment will be used in this embodiment.

In this embodiment, firstly the wireless device 21 obtains the feature information F1 by performing the first discovery procedure P11 to measure the terminal signal S1 of the under-discovered wireless device 11. Similarly, the under-discovered wireless device 11 obtains a piece of third feature information by performing the first discovery procedure P11 to measure a third terminal signal transmitted by the wireless device 21 to the second network server 20. Herein, it is assumed that the first discovery procedure P11 used by the under-discovered wireless device 11 is a first discovery procedure P11″ for distinguishing purpose.

It shall be particularly appreciated that, because the wireless device 21 and the under-discovered wireless device 11 don't know each other's related information before the first discovery procedure P11 and the first discovery procedure P11″ are performed, the wireless device 21 and the under-discovered device 11 don't know when and at which frequency the counterpart will transmit the terminal signal S1/the third terminal signal. Therefore, the wireless device 21 and the under-discovered wireless device 11 obtain the feature information F1 and the third feature information respectively by listening in all periods and at all frequencies.

When the third terminal signal has been transmitted by the wireless device 21 and the terminal signal S1 has been transmitted by the under-discovered wireless device 11, the first network server 10 creates and stores a piece of uplink scheduled information S8 according to the third terminal signal of the wireless device 21 and the terminal signal S1 of the under-discovered wireless device 11. The uplink scheduled information S8 is used to record an information schedule that the first network server 10 makes for the services it provides. For example, the uplink scheduled information S8 is an RNTI-resource mapping table that records the correspondence relationships between each RNTI and the resources used.

Thereafter, the wireless device 21 and the under-discovered wireless device 11 record the feature information F1 and the third feature information into a third uplink mapping table T3 and a fourth uplink mapping table T4 respectively and transmit the third uplink mapping table T3 and the fourth uplink mapping table T4 to the first network server 10 respectively.

Then, the first network server 10 determines that the wireless device 21 and the under-discovered wireless device 11 are within each other's discovery coverage based on determinations that the feature information F1 in the third uplink mapping table T3 is higher than a predetermined threshold and the third feature information in the fourth uplink mapping table T4 is higher than the predetermined threshold and according to the uplink scheduled information S8 stored in the first network server 10. Thereby, a determination result R4 is generated and transmitted to the wireless device 21 and the under-discovered wireless device 11 so that the wireless device 21 can identify that the under-discovered wireless device 11 is located within the discovery coverage thereof according to the determination result R4 and the under-discovered wireless device 11 can also identify that the wireless device 21 is located within the discovery coverage thereof according to the determination result R4.

As can be known from the above embodiments, the wireless device of the present invention can obtain feature information of an under-discovered wireless device by means of a resource pre-existing between the under-discovered wireless network and the network server (e.g., a channel and a signal in the LTE architecture), and learn from the feature information whether the under-discovered wireless device is located within the discovery coverage of the wireless device. Thereby, the purpose of proximity discovery can be achieved. Because the present invention allows the wireless device to perform proximity discovery without the need of a new resource, the availability and the utilization factor of the resources of the wireless network system can be remarkably improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless device for discovering an under-discovered wireless device, the under-discovered wireless device being served by a first network server and transmitting a terminal signal to the first network server at a specific frequency and in a specific period, the wireless device comprising:
a transceiver; and
a processor electrically connected to the transceiver, being configured to obtain a piece of feature information related to the terminal signal by listening to the terminal signal via the transceiver, and identify that the under-discovered wireless device is in a discovery coverage of the wireless device according to a determination result that the feature information is higher than a predetermined threshold.

2. The wireless device as claimed in claim 1, wherein the first network server is configured to serve the wireless device;
wherein before the terminal signal is transmitted, the transceiver further receives a piece of discovery information and a control signal from the first network server, the discovery information is one of a broadcast signal, a unicast signal and a multicast signal, and the processor listens to the terminal signal via the transceiver at the specific frequency and in the specific period according to the discovery information and the control signal.

3. The wireless device as claimed in claim 2, wherein, before receiving the discovery information, the transceiver further transmits a piece of specific service item information to the first network server so that the first network server transmits the discovery information according to the specific service item information.

4. The wireless device as claimed in claim 2, wherein the discovery information carries a mapping table, and the processor listens to the terminal signal via the transceiver at the specific frequency and in the specific period according to the mapping table and the control signal.

5. The wireless device as claimed in claim 1, wherein the transceiver further receives a specific mapping table before listening to the terminal signal, and the processor listens to the terminal signal at the specific frequency and in the specific period via the transceiver according to the specific mapping table.

6. The wireless device as claimed in claim 1, wherein the feature information and the predetermined threshold are one of: a power value and a predetermined power threshold, a signal to interference plus noise ratio (SINR) value and a predetermined SINR threshold, and a normalized power value and a predetermined power threshold.

7. The wireless device as claimed in claim 1, wherein the terminal signal is a reference signal, an unknown sequence is measured by the processor when listening to the terminal signal via the transceiver, and the processor calculates a relevance value between the unknown sequence and a reference sequence corresponding to the terminal signal;
wherein the feature information is the relevance value, and the predetermined threshold is a predetermined relevance value.

8. The wireless device as claimed in claim 1, wherein the specific frequency and the specific period correspond to a specific uplink channel, the terminal signal is transmitted in the specific uplink channel, an unknown sequence is measured by the processor when listening to the terminal signal via the transceiver, and the processor calculates a relevance value between the unknown sequence and a reference sequence corresponding to the terminal signal;
wherein the feature information is the relevance value, and the predetermined threshold is a predetermined relevance value.

9. The wireless device as claimed in claim 1, wherein the determination result is generated by the processor when determining that the feature information is higher than a predetermined threshold.

10. The wireless device as claimed in claim 1, wherein the first network server serves the wireless device;
wherein the transceiver is further configured to transmit the feature information to the first network server so that the first network server determines that the feature information is higher than a predetermined threshold to generate the determination result, and the transceiver receives the determination result from the first network server.

11. The wireless device as claimed in claim 1, further comprising a storage configured to store a piece of predetermined uplink resource allocation information of the under-discovered wireless device, and the processor uses the predetermined uplink resource allocation information to enable the transceiver to listen to the terminal signal at the specific frequency and in the specific period.

12. The wireless device as claimed in claim 1, wherein a second network server serves the wireless device, and both the first network server and the second network server belongs to a wireless network system;
wherein the transceiver is further configured to transmit the feature information to the second network server so that the second network server acquires a piece of scheduled information of the first network server from the first network server and generates the determination result according to the scheduled information and based on determination that the feature information is higher than the predetermined threshold.

13. A wireless network system, comprising:
a first network server;
an under-discovered wireless device, being served by the first network server and configured to transmit a terminal signal to the first network server at a specific frequency and in a specific period; and
a wireless device, being configured to discover the under-discovered wireless device and comprising:
a transceiver; and
a processor electrically connected to the transceiver, being configured to obtain a piece of feature information related to the terminal signal by listening to the terminal signal via the transceiver, and identify that the under-discovered wireless device is in a discovery coverage of the wireless device according to a determination result that the feature information is higher than a predetermined threshold.

14. The wireless network system as claimed in claim 13, wherein the first network server is configured to serve the wireless device;
wherein before the terminal signal is transmitted, the transceiver further receives a piece of discovery information and a control signal from the first network server, the discovery information is one of a broadcast signal, a unicast signal and a multicast signal, and the processor listens to the terminal signal via the transceiver at the specific frequency and in the specific period according to the discovery information and the control signal.

15. The wireless network system as claimed in claim 14, wherein, before transmitting the discovery information, the first network server further receives a piece of specific service item information from an Evolved Packet Core (EPC), and the first network server transmits the discovery information according to the specific service item information.

16. The wireless network system as claimed in claim 14, wherein, before receiving the discovery information, the transceiver further transmits a piece of specific service item information to the first network server so that the first network server transmits the discovery information according to the specific service item information.

17. The wireless network system as claimed in claim 14, wherein the discovery information carries a mapping table, and the processor listens to the terminal signal via the transceiver at the specific frequency and in the specific period according to the mapping table and the control signal.

18. The wireless network system as claimed in claim 13, wherein the transceiver further receives a specific mapping table before listening to the terminal signal, and the processor listens to the terminal signal at the specific frequency and in the specific period via the transceiver according to the specific mapping table.

19. The wireless network system as claimed in claim 13, wherein the feature information and the predetermined threshold are one of: a power value and a predetermined power threshold, a signal to interference plus noise ratio (SINR) value and a predetermined SINR threshold, and a normalized power value and a predetermined power threshold.

20. The wireless network system as claimed in claim 13, wherein the terminal signal is a reference signal, an unknown sequence is measured by the processor when listening to the terminal signal via the transceiver, and the processor calculates a relevance value between the unknown sequence and a reference sequence corresponding to the terminal signal;
wherein the feature information is the relevance value, and the predetermined threshold is a predetermined relevance value.

21. The wireless network system as claimed in claim 13, wherein the specific frequency and the specific period correspond to a specific uplink channel, the terminal signal is transmitted in the specific uplink channel, an unknown sequence is measured by the processor when listening to the terminal signal via the transceiver, and the processor calculates a relevance value between the unknown sequence and a reference sequence corresponding to the terminal signal;
wherein the feature information is the relevance value, and the predetermined threshold is a predetermined relevance value.

22. The wireless network system as claimed in claim 13, wherein the determination result is generated by the processor when determining that the feature information is higher than a predetermined threshold.

23. The wireless network system as claimed in claim 13, wherein the first network server serves the wireless device;
wherein the transceiver is further configured to transmit the feature information to the first network server so that the first network server determines that the feature information is higher than a predetermined threshold to generate the determination result, and the transceiver receives the determination result from the first network server.

24. The wireless network system as claimed in claim 13, wherein the wireless device further comprises a storage configured to store a piece of predetermined uplink resource allocation information of the under-discovered wireless device, and the processor uses the predetermined uplink resource allocation information to enable the transceiver to listen to the terminal signal at the specific frequency and in the specific period.

25. The wireless network system as claimed in claim 13, wherein the first network server has a piece of scheduled information stored therein and receives the feature information from the transceiver, and the first network server generates the determination result based on determination that the feature information is higher than the predetermined threshold and according to the scheduled information.

26. The wireless network system as claimed in claim 13, further comprising a second network server that serves the wireless device;
wherein the transceiver is further configured to transmit the feature information to the second network server so that the second network server acquires a piece of scheduled information of the first network server from the first network server and generates the determination result according to the scheduled information and based on determination that the feature information is higher than the predetermined threshold.

27. A wireless device for discovering an under-discovered wireless device, the under-discovered wireless device being served by a first network server and transmitting a terminal signal to the first network server at a specific frequency and in a specific period, the wireless device comprising:
a transceiver; and
a processor electrically connected to the transceiver, being configured to obtain a piece of feature information related to the terminal signal by listening to the terminal signal via the transceiver, and identify that the under-discovered wireless device is in a discovery coverage of the wireless device according to a determination result that the normalized feature information is higher than a predetermined threshold.

28. A wireless network system, comprising:
a first network server;
an under-discovered wireless device, being served by the first network server and configured to transmit a terminal signal to the first network server at a specific frequency and in a specific period; and
a wireless device, being configured to discover the under-discovered wireless device and comprising:
a transceiver; and
a processor electrically connected to the transceiver, being configured to obtain a piece of feature information related to the terminal signal by listening to the terminal signal via the transceiver, and identify that the under-discovered wireless device is in a discovery coverage of the wireless device according to a determination result that the normalized feature information is higher than a predetermined threshold.
